(19) United States
(12) Patent Application Publication
(10) Pub. No.: US 2022/0180436 A1
(43) Pub. Date: Jun. 9, 2022

(54) RESOURCE CONVERSION DATA PROCESSING METHOD AND APPARATUS, COMPUTER DEVICE, AND STORAGE MEDIUM

(71) Applicant: Tencent Technology (Shenzhen) Company Limited, Shenzhen (CN)

(72) Inventors: Jie LI, Shenzhen (CN); Jinsheng BAO, Shenzhen (CN)

(73) Assignee: Tencent Technology (Shenzhen) Company Limited, Shenzhen (CN)

(21) Appl. No.: 17/678,490

(22) Filed: Feb. 23, 2022

Related U.S. Application Data
(63) Continuation of application No. PCT/CN2020/128063, filed on Nov. 11, 2020.

(30) Foreign Application Priority Data
Mar. 6, 2020 (CN) 202010152445.7

(51) Int. Cl. G06Q 40/04

(52) U.S. Cl. CPC G06Q 40/04

(57) ABSTRACT

A resource conversion method is described. A first conversion record set of first records and a second conversion record set of second records can be determined. An original resource is converted to a target resource in each record. The original resource in the first records is a first type resource, and the target resource in each of the second records is the first type resource. A first quantity of original resources corresponding to the first records is determined. A second quantity of target resources corresponding to the records is determined. A resource conversion between the first type resource and a resource of a different type can be performed according to a difference between the first quantity and the second quantity.

### RELATED APPLICATION

This application is a continuation of International Application No. PCT/CN2020/128063, filed on Nov. 11, 2020, which claims priority to Chinese Patent Application No. 202010152445.7, filed on Mar. 6, 2020. The disclosures of the prior applications are hereby incorporated by reference in their entirety FIELD OF THE TECHNOLOGY

This application relates to the field of Internet technologies, including a resource conversion data processing method and apparatus, a computer device, and a storage medium.

### BACKGROUND OF THE DISCLOSURE

With the development of Internet technologies, various types of resource conversion, such as a user performing currency exchange on an Internet platform, has emerged.

In the related technology, when a server of an Internet platform receives a resource conversion request such as a currency exchange request sent by a user terminal, it is usually necessary to interact with a resource conversion server (or conversion server) such as a bank server according to the resource conversion request, to complete a resource conversion process and perform resource conversion through the Internet. However, in the related technology, a problem may frequently occur that the resource conversion demand for the server can become overwhelming due to the large volume of the resource conversion request.

### SUMMARY

Aspects of the disclosure provide a resource conversion method. The method can include determining a first conversion record set and a second conversion record set. The first conversion record set includes at least one first resource conversion record. The second conversion record set includes at least one second resource conversion record. An original resource is converted to a target resource in each of the at least one first resource conversion record and the at least one second resource conversion record. The original resource in each of the at least one first resource conversion record is a first type resource, and the target resource in each of the at least one second resource conversion record is the first type resource. A quantity of original resources corresponding to the at least one first resource conversion record in the first conversion record set is determined as a first original quantity. A quantity of target resources corresponding to the at least one second resource conversion record in the second conversion record set is determined as a first target quantity. A first conversion quantity corresponding to the first type resource is determined according to a difference between the first original quantity and the first target quantity. Resource conversion between the first type resource and a resource of a different type can be performed according to the first conversion quantity corresponding to the first type resource.

Aspects of the disclosure provide a resource conversion apparatus or server. The apparatus or server can include processing circuitry configured to determine a first conversion record set and a second conversion record set. The first conversion record set includes at least one first resource conversion record. The second conversion record set includes at least one second resource conversion record. An original resource is converted to a target resource in each of the at least one first resource conversion record and the at least one second resource conversion record. The original resource in each of the at least one first resource conversion record is a first type resource, and the target resource in each of the at least one second resource conversion record is the first type resource. A quantity of original resources corresponding to the at least one first resource conversion record in the first conversion record set is determined as a first original quantity. A quantity of target resources corresponding to the at least one second resource conversion record in the second conversion record set is determined as a first target quantity. A first conversion quantity corresponding to the first type resource is determined according to a difference between the first original quantity and the first target quantity. Resource conversion between the first type resource and a resource of a different type can be performed according to the first conversion quantity corresponding to the first type resource.

Aspects of the disclosure provide a non-transitory computer-readable storage medium storing instructions which when executed by at least one processor cause the at least one processor to perform the resource conversion method.

### BRIEF DESCRIPTION OF THE DRAWINGS

To describe the technical solutions in the embodiments of this application more clearly, the following briefly introduces the accompanying drawings for describing the embodiments. The accompanying drawings in the following description show only some embodiments of this application, and a person of ordinary skill in the art may still derive other accompanying drawings from these accompanying drawings.

FIG. 1 is a diagram of an application environment of a resource conversion data processing method according to some embodiments.

FIG. 2 is a schematic flowchart of a resource conversion data processing method according to some embodiments.

FIG. 3 is a schematic diagram of an implementation of a resource conversion data processing method according to some embodiments.

FIG. 4 is a schematic flowchart of a resource conversion data processing method according to some other embodiments.

FIG. 5 is a schematic diagram of determining a resource conversion relationship according to some embodiments.

FIG. 6A is a diagram of a principle of currency exchange according to some embodiments.

FIG. 6B is a schematic diagram of interfaces of a terminal before currency exchange and after currency exchange according to some embodiments.

FIG. 7 is a schematic flowchart of a resource conversion data processing method according to some other embodiments.

FIG. 8 is a schematic diagram of a principle of a resource conversion data processing method according to some other embodiments.

FIG. 9 is a structural block diagram of a resource conversion data processing apparatus according to some embodiments.

FIG. 10 is an internal structure diagram of a computer device according to some embodiments.

### DESCRIPTION OF EMBODIMENTS

To illustrate the objectives, technical solutions, and advantages of this application, the following further describes this application in detail with reference to the accompanying drawings and the embodiments. It is to be understood that the specific embodiments described herein are only used for explaining this application, and are not used for limiting this application.

Before embodiments of this application are described in detail, some involved concepts are explained as follows:

Electronic stored value wallet (referred to as an electronic wallet) is an Internet payment tool, with an Internet electronic account as a carrier, issued by a payment institution such as third-party payment institution and recharged by using a deposit channel, for at least one application scenario of consumption, transfer, or remittance. An electronic wallet can also be referred to as a digital wallet or an e-wallet in some embodiments. Examples of electronic-wallet-based service can include WeChat Pay, Google Pay, and the like.

Electronic stored value wallet account (referred to as a wallet account below) is a fund carrier of the electronic wallet and can record account changes such as an income and an expenditure of the electronic wallet in a form of balance.

Deposit refers to that a user transfers funds into the electronic wallet to form a wallet balance. For example, a wallet account can be recharged by using a bank card during a deposit process.

Multi-currency account refers to a wallet account that can support different currencies. For example, accounts associated with other types of currency such as United States dollar (USD) or Hong Kong dollar may further be set in addition to Renminbi (RMB) in a multi-currency account. As a carrier of currency, the multi-currency account may exchange currency in an electronic manner and may also be referred to as a virtual multi-currency account.

Currency exchange is an exchange behavior or process between different currencies in the electronic wallet. During exchange, exchange may be performed according to an exchange rate provided by an electronic wallet platform at a transaction time point.

User is a user of the electronic wallet. For example, an individual obtains a permission to use the electronic wallet after registration and authentication at an electronic wallet platform.

Platform refers to an electronic wallet system operated by an operator of the electronic wallet. For example, the operator can be a specific institution approved by a regulatory department to operate.

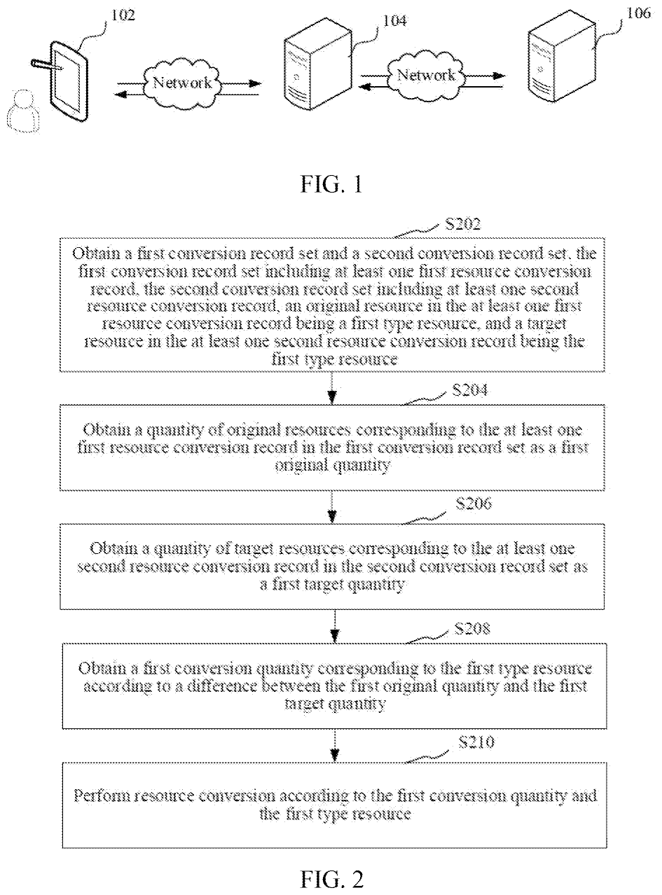

The resource conversion data processing method provided in this application is applicable to an application environment shown in FIG. 1, and the application environment includes a terminal 102, an intermediate server 104, and a resource conversion server (or conversion server) 106. The intermediate server 104 may be a server of a third-party platform (and may be referred to as a resource conversion server associated with the third-party platform). For example, the intermediate server 104 may be a server corresponding to a target application, and the target application may be an application such as an instant messaging application providing a resource conversion function. The resource conversion server 106 may be, for example, a server managed by a bank. The terminal 102 may be a terminal hold by a user. The user may transmit a currency exchange request to the intermediate server 104 by using the terminal 102, and the intermediate server 104 changes a quantity of currencies in an account of the user in response to the request, for example, converts a first resource quantity of resources A in the account of the user to a second resource quantity of resources B, and generates a resource conversion record. The intermediate server 104 may obtain a batch of resource conversion records every preset time and perform the method provided in this embodiment of this application, to obtain a first conversion quantity corresponding to a first type resource. The intermediate server 104 transmits a resource conversion request to the resource conversion server 106 to request to convert the first conversion quantity of the first type resources to resources of another type or convert resources of another type to the first conversion quantity of the first type resources.

The terminal 102 communicates with the intermediate server 104 through a network. The servers may also communicate with each other through a network. The terminal 102 may be, but not limited to, a personal computer, a notebook computer, a smartphone, a tablet computer, and a portable wearable device. The intermediate server 104 and the resource conversion server 106 may be respectively implemented by an independent server or a server cluster including a plurality of servers.

In some embodiments, as shown in FIG. 2, a resource conversion data processing method is provided. An example in which the method is applicable to the intermediate server 104 in FIG. 1 is used for description, and, in an example, the method includes the following steps.

In Step S202, a first conversion record set and a second conversion record set are obtained, the first conversion record set including one or more first resource conversion records, the second conversion record set including one or more second resource conversion records, an original resource in the one or more first resource conversion records being a first type resource, and a target resource in the one or more second resource conversion records being the first type resource.

For example, a resource may be circulated on the Internet by using an electronic account. The resource may be currency, gold, or the like. For example, one type of currency corresponds to one type of resource. A quantity of resources owned by a user may be represented in an electronic form. For example, a quantity of RMB owned by the user may be represented in an electronic wallet. A type of the resource is determined according to a specific condition. For example, for currency, there may be a type such as USD, RMB, British pound sterling (GBP), or Hong Kong dollar. The first type resource may be any type of resource, for example, RMB.

Resource conversion refers to that one resource is converted to another resource. The resource conversion may be performed in an account of a same user. For example, a user A converts RMB in an account thereof to USD. The resource conversion may alternatively be performed between accounts of different users. For example, a user A transfers 100 yuan to a user B, but an account of the user B is a USD account, so that an intermediate server may convert 100 yuan to 15 dollars during the transfer. The original resource is a resource before conversion, and the target resource is a resource after conversion. For example, if RMB is converted to USD, RMB is an original resource and USD is a target resource. If USD is converted to RMB, USD is an original resource and RMB is a target resource.

A resource conversion record is a record of a resource conversion behavior (or event). The resource conversion record may include a type identifier of the original resource, a quantity of original resources, a type identifier of the target resource, and a quantity of target resources. For example, if a user A exchanges 700 yuan for 100 dollars, in a resource conversion record, a type identifier of an original resource is an identifier of RMB, for example, RMB, and a quantity of original resources are 700. A type identifier of a target resource is an identifier of USD, for example, USD, and a quantity of target resources are 100.

The first conversion record set may include one or more first resource conversion records, and the second conversion record set may also include one or more second resource conversion records. More refers to at least two. The original resource in the first resource conversion record and the target resource in the second resource conversion record are resources of the same type, for example, RMB. A target resource in the first resource conversion record and an original resource in the second resource conversion record may be the same or may be different. For example, the first resource conversion record is a resource conversion record of exchanging RMB for USD, and the second resource conversion record is a resource conversion record of exchanging USD for RMB.

In some embodiments, the first resource conversion record and the second resource conversion record may be obtained from a candidate resource conversion record set. A resource conversion record in the candidate resource conversion record set may be selected randomly, or a resource conversion record of which a resource conversion time is within a first resource conversion time range may be obtained to form the candidate resource conversion record set. A resource conversion record with an original resource being a first type resource and a target resource being a second type resource is obtained from the candidate resource conversion record set as the first resource conversion record. A resource conversion record with an original resource being the second type resource and a target resource being the first type resource is obtained from the candidate resource conversion record set as the second resource conversion record. That is, a resource conversion direction of the first resource conversion record is opposite to that of the second resource conversion record.

For example, a length of the first resource conversion time range may be set as appropriate, for example, to be one hour. For example, one or more resource conversion records generated within a resource conversion time range with a time length being a preset time period may be obtained every preset time period, to form a candidate resource conversion record set, conversion records in which an original resource and a target resource are exchanged are obtained from the candidate resource conversion record set, one resource conversion record is used as a first resource conversion record, and the other resource conversion record with an opposite conversion direction is used as a second resource conversion record. For example, the first resource conversion record is a resource conversion record of exchanging RMB for USD, and the second resource conversion record is a resource conversion record of exchanging USD for RMB.

In some embodiments, the resource conversion record is generated according to a resource conversion request corresponding to a user. For example, when a resource conversion request transmitted by a terminal of the user is received, resource conversion on an account corresponding to the user may be completed in response to the resource conversion request in real time, and a resource conversion record is generated. In an example, the intermediate server may be a server corresponding to an instant messaging application. Within one hour, for example, a plurality of users may respectively transmit resource conversion requests to the intermediate server by using instant messaging applications, and the server performs resource conversion on accounts of the users in response to the resource conversion requests, and generates resource conversion records.

In Step S204, a quantity of original resources corresponding to the one or more first resource conversion records in the first conversion record set is obtained as a first original quantity.

In an example, a quantity of original resources in the one or more first resource conversion records in the first conversion record set may be counted, to obtain a first original quantity. Counting refers to performing summation. For example, there are two first resource conversion records h1 and h2 in the first conversion record set, a first type resource is RMB, h1 is a record of converting 702 yuan to 100 dollars, and h2 is a record of converting 1404 yuan to 200 dollars, and a first original quantity is 702+1404=2106.

In Step S206, a quantity of target resources corresponding to the one or more second resource conversion records in the second conversion record set are obtained as a first target quantity.

In an example, a quantity of target resources in the one or more second resource conversion records in the second conversion record set may be counted, to obtain a first target quantity. For example, there are three second resource conversion records k1, k2, and k3 in the second conversion record set, a first type resource is RMB, and k1 is a record of converting 100 dollars to 698 yuan, k2 is a record of converting 1000 dollars to 6980 yuan, and k3 is a record of converting 50 dollars to 349 yuan, and a first target quantity is 698+6980+349=8027.

In Step S208, a first conversion quantity corresponding to the first type resource according to a difference between the first original quantity and the first target quantity is obtained.

In an example, the first conversion quantity may be an absolute value of a difference between the first original quantity and the first target quantity. For example, it is assumed that the first target quantity is 8027 and the first original quantity is 2106, the first conversion quantity is 8027−2106=5921. Certainly, the first conversion quantity may alternatively be further obtained through calculation according to the difference. For example, rounding off may be performed on the absolute value of the difference, to obtain the first conversion quantity.

In Step S210, a resource conversion according to the first conversion quantity and the first type resource is performed.

In an example, the first conversion quantity of the first type resources may be exchanged for resources of another type, or resources of another type may be exchanged for the first conversion quantity of the first type resources. The intermediate server may transmit a resource conversion request to a resource conversion server, to request to perform resource conversion.

In some embodiments, before the resource conversion request is transmitted to the resource conversion server to request to perform resource conversion, a resource in which conversion needs to be performed with the first type resource may be determined. For example, the target resource in the first resource conversion records may be used as a resource in which conversion is performed with the first type resource. Alternatively, a preset type resource may be used as a resource in which conversion is performed with the first type resource.

In some embodiments, a target conversion manner corresponding to the first type resource may be determined according to a magnitude relationship between the first original quantity and the first target quantity, and the first conversion quantity of the first type resources are converted in the target conversion manner. The target conversion manner may be transfer-in or transfer-out. If the target conversion manner is transfer-in, a resource of another type such as a second type resource is exchanged for (converted to) the first type resource. If the target conversion manner is transfer-out, the first type resource is exchanged for (converted to) a resource of another type such as a second type resource.

In some embodiments, in response to the first original quantity being greater than the first target quantity, the target conversion manner is transfer-out, and the converting the first conversion quantity of the first type resources in the target conversion manner includes: transmitting a target conversion request to a resource conversion server, the target conversion request being used for requesting to transfer out the first conversion quantity of the first type resources. In a case that the first original quantity is less than the first target quantity, the target conversion manner is transfer-in, and the converting the first conversion quantity of the first type resources in the target conversion manner includes: transmitting a target conversion request to a resource conversion server, the target conversion request being used for requesting to transfer in the first conversion quantity of the first type resources. It may be understood that when the first original quantity is equal to the first target quantity, a total quantity of first type resources managed by a platform is not changed in general, so that no conversion is required. In this way, even if a plurality of users perform currency exchange in the platform, the intermediate server does not need to interact with the resource conversion server for currency exchange.

For example, it is assumed that a first target quantity of RMB is 8027, and a first original quantity is 2106. It indicates that generally, users exchange 2106 yuan for another currency and exchange the other currency for 8027 yuan. In conclusion, a total quantity of RMB of all users on the platform is increased by 8027−2106=5921 yuan, so that a corresponding quantity of RMB needs to be transferred in (the other currency is converted to RMB). A third-party platform may open a resource account in a bank, the intermediate server may transmit a currency exchange request of exchanging USD for 5921 yuan to a bank server by using the account, and the bank server may add 5921 yuan to the resource account of the third-party platform and subtract dollars equivalent to 5921 yuan from the resource account of the third-party platform.

In some embodiments, a target resource in the first resource conversion record is a second type resource, an original resource in the second resource conversion record is the second type resource, and the performing resource conversion according to the first conversion quantity and the first type resource includes: transmitting a target conversion request to a resource conversion server, the target conversion request being used for requesting to convert the second type resources to the first conversion quantity of the first type resources or convert the first conversion quantity of first type resources to the second type resources.

In an example, the first resource conversion record and the second resource conversion record involve conversion between two same types of resources with opposite conversion directions. For example, the first resource conversion record is a conversion record of exchanging RMB for GBP, and the second resource conversion record is a conversion record of exchanging GBP for RMB. Through conversion between the first type resource and the second type resource, a change of quantities of currencies managed by an operator corresponding to the intermediate server can match a change of total quantities of currencies of the users in the platform.

For example, within an hour, some users exchange RMB for USD, and some users exchange USD for RMB. At least one of an RMB increment or a USD increment may be counted according to resource conversion records in the past one hour. If a total quantity of RMB is reduced and a total quantity of USD is increased, the intermediate server may transmit a request of exchanging RMB for USD to the bank server. In this way, a total quantity of RMB managed by the platform is correspondingly reduced, and a total quantity of USD is increased, which matches currency needs of the users. For example, on February 1, a user applies to exchange 7000 yuan for 100 dollars. On the same day, another user applies to exchange 800 dollars for 5600 yuan. The platform may display exchange results in real time when facing the users. However, during background processing, amounts of RMB are offset against each other, when requesting an exchange from the bank, the platform requests to exchange 7000−5600=1400 yuan for 1000−800=200 dollars. In this way, an amount of interactions between the intermediate server and the bank server is reduced, to reduce the resource exchange pressure (or load) on the intermediate server, and because amounts of currency exchange are offset against each other, the exchanged amounts are reduced, thereby reducing the currency exchange costs.

In some embodiments, it may be understood that values of resource transfer-in and transfer-out may be different. For example, a foreign exchange service includes two services of foreign exchange purchase and settlement of exchange. The foreign exchange purchase refers to exchanging domestic currency for foreign currency and performing settlement by using a price of selling the domestic currency, and the price of the domestic currency is referred to as an ask rate. The settlement of exchange refers to buying the domestic currency by using the foreign currency and performing settlement by using a price of buying the domestic currency, and the price of the domestic currency is referred to as a bid rate. The domestic currency is a fiat money of a geographical region of a user. The geographical region may be a country or a region. For example, when a user is in China, the domestic currency is RMB. Generally, for a foreign exchange service, an ask rate is higher than a bid rate (ask is greater than bid), and a difference is an exchange charge of a bank, that is, earnings of the bank. For example, when RMB and USD are exchanged, an ask rate of RMB is 7.02 yuan, and a bid rate of RMB is 6.98 yuan. That is, when a user exchanges RMB for USD, 7.02 yuan may be exchanged for one dollar, and when the user exchanges USD for RMB, one dollar may be exchanged for 6.98 yuan.

The resource conversion refers to that one resource is converted to another resource, which involves two resources. Therefore, one resource may be used as a first type resource, and the other resource may be used as a second type resource. Resource conversion is performed based on the first type resource, and the first type resource may be specifically set. For example, for conversion between USD and RMB, RMB may be preset as the first type resource, and USD may be used as the second type resource. Alternatively, the first type resource and the second type resource may be determined according to magnitudes of an original quantity of resources and a target quantity of resources obtained through calculation. For example, currencies of which a transfer-in quantity is greater than a transfer-out quantity may be used as a first type resource in the past one hour.

In an example, conversion is performed according to one unit of RMB. It is assumed that when a user performs currency exchange in a server of a platform, a foreign exchange purchase (ask) rate of USD is 7.02 yuan, and a settlement of exchange (bid) rate is 6.98 yuan. It is assumed that the server of the platform has six conversion records between RMB and LSD of a user, which are a, b, c, d, e, and f. Meanings of the six records a, b, c, d, e, and f are shown in Table 1. A number in parentheses represents that an increment of a currency is negative. For example, (702.00) represents that an increment of RMB is −702.00 yuan in the resource conversion record. If uniform resource exchange is performed by using the four records a, b, c, and d as a batch of resource conversion records, an increment of RMB may be calculated as −702+100−7020+698=−6924 yuan. An increment of USD is 100−14.33+1000−100=985.67 dollars. Therefore, if a resource of which an increment is positive is used as the first type resource, USD is the first type resource. It is assumed that when the platform purchases USD from the bank, a rate is also 7.02 yuan per dollar, accordingly 985.67*7.02=6919.42 yuan may be exchanged for 985.67 dollars. In another example, if uniform resource exchange is performed by using the two records a and f as a batch of resource conversion records, an increment of RMB may be calculated as −702+702=0 yuan. An increment of USD is 100−100.57=−0.57 dollars. If RMB is used as the first type resource, because the increment is 0, the intermediate server does not need to perform resource exchange with the bank server. If USD is used as the first type resource, because the increment is negative, the intermediate server may exchange 0.57 dollars for RMB.

According to the resource conversion data processing method, an original resource in one or more first resource conversion records is a first type resource, a target resource in one or more second resource conversion records is the first type resource, that is, the original resource in the one or more first resource conversion records has a same type as the target resource in the one or more second resource conversion records, a quantity of original resources corresponding to the one or more first resource conversion records is obtained as a first original quantity, and a quantity of target resources corresponding to the one or more second resource conversion records is obtained as a first target quantity. Uniform resource conversion is performed on the first type resource according to a first resource conversion quantity obtained according to a difference between the first original quantity and the first target quantity. The first resource exchange quantity obtained according to the difference between the first original quantity and the first target quantity is equivalent to that quantities of same type of resources in different conversion directions, which corresponds to a final effect in which the first type resource is respectively converted according to the first resource conversion record and the second resource conversion record. Therefore, uniform resource conversion is performed according to the first conversion quantity and the first type resource, to reduce a number of resource conversions, thereby reducing the resource conversion pressure (load).

TABLE 1
Resource conversion record detail table

| | RMB | USD | | Transaction | |
|---|---|---|---|---|---|
| Conversion | (domestic | (foreign | Transaction | exchange | |
| record | currency) | currency) | type | rate | Meaning |
| a | (702.00) | 100.00 | Ask | 7.02 | Exchange 702 yuan for 100 |
| | | | | | dollars |
| b | 100.00 | (14.33) | Bid | 6.98 | Exchange 14.33 dollars for |
| | | | | | 100 yuan |
| c | (7020.00) | 1000 | Ask | 7.02 | Exchange 7020 yuan for |
| | | | | | 1000 dollars |
| d | 698 | (100.00) | Bid | 6.98 | Exchange 100 dollars for |
| | | | | | 698 yuan |
| e | 6980 | (1000.00) | Bid | 6.98 | Exchange 1000 dollars for |
| | | | | | 6980 yuan |
| f | 702.00 | (100.57) | Bid | 6.98 | Exchange 100.57 dollars for |
| | | | | | 702 yuan |

The resource conversion data processing method provided in this embodiment of this application is applicable to a currency exchange service scenario provided by a third-party platform. A user may perform currency exchange on the third-party platform. A server corresponding to the third-party platform may respond to a currency exchange request corresponding to the user in real time, so that quantities of currencies in an electronic wallet of the user may be changed in real time. However, currency exchange directions of different users on the platform may be different. For example, there are currency exchange requests of different directions everyday such as RMB against USD, USD against RMB, or JPY against USD. If the intermediate server interacts with a bank server once every time a currency exchange request is received, and applies to buy or sell currencies according to the currency exchange request, the intermediate server has a large running workload. Therefore, uniform exchange may be performed in batches. For example, currency conversion records involving the same two currencies (a first type resource and a second type resource) with opposite exchange directions are obtained every preset time period. An original quantity and a target quantity that correspond to any currency (for example, the first type resource) of the two currencies may be counted, and an increment of the currency is calculated according to a difference between the original quantity and the target quantity. If the increment is positive, that is, a total quantity of the currencies (first-type resources) is increased, the other currency (second-type resources) is exchanged for the currency, and if the increment is negative, the currency (first-type resources) is transferred out. By adopting a real-time mechanism to respond to a user-oriented exchange request, and adopting a batch aggregation mechanism for bank-oriented exchange processing, not only the timeliness of currency exchange for the user is ensured, but also the workload and the resource exchange costs caused by frequent interaction with a resource conversion server is reduced.

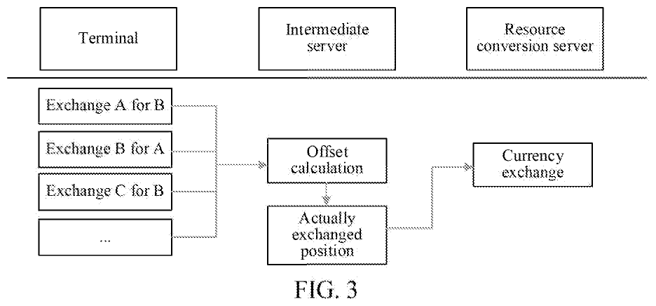

For example, FIG. 3 is a schematic diagram of an implementation in which terminals, intermediate servers, and resource conversion servers corresponding to different wallet users perform resource conversion data processing method according to some embodiments. Different wallet users may perform currency exchange by using corresponding terminals. For example, a user exchanges a currency A for a currency B, and another user exchanges the currency B for the currency A. A position refers to a difference between a resource transfer-in quantity and a resource transfer-out quantity. If the transfer-in quantity (a first target quantity) is greater than the transfer-out quantity (a first original quantity), it is referred to as “a long position”, and if the transfer-out quantity is greater than the transfer-in quantity, it is referred to as “a short position”. The intermediate server may obtain resource conversion records with opposite resource conversion directions and perform offset and calculation, to obtain a position of any currency of two currencies. If the currency is a long position, it indicates that the other currency is a short position. Therefore, the intermediate server may interact with a resource conversion server and exchange a short position resource for a long position resource, to complete currency exchange.

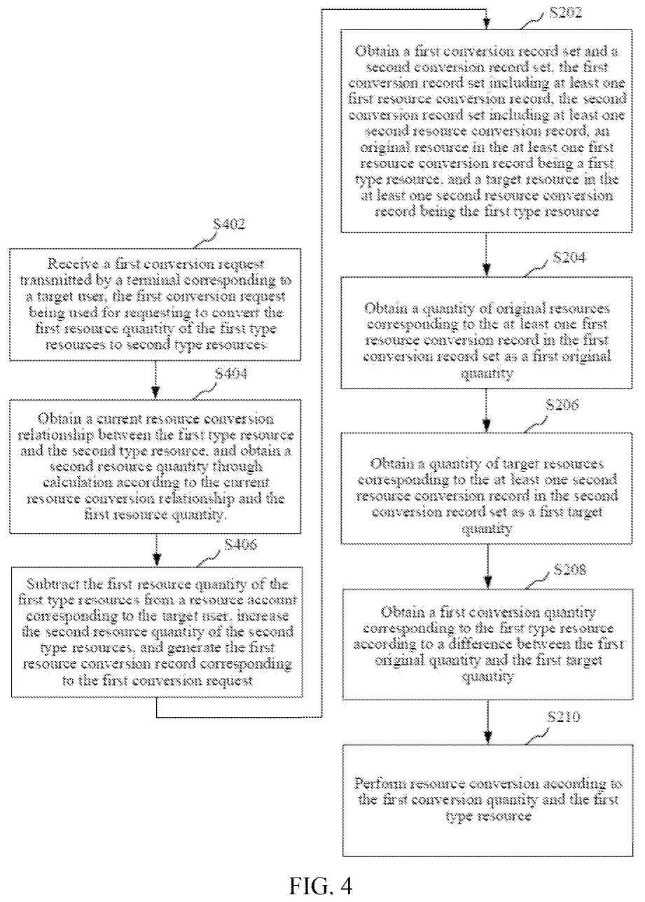

In some embodiments, the resource conversion record is generated according to a resource conversion request of a user. The resource conversion data processing method shown in FIG. 4 may further include the following steps in addition to S202-S210.

In Step S402, a first conversion request transmitted by a terminal corresponding to a target user is received, the first conversion request being used for requesting conversion of the first resource quantity of the first type resources to second type resources.

Specifically, the first conversion request may carry a type identifier of the original resource and a type identifier of the target resource. The type identifier of the original resource is a resource identifier of the first type resource, and the type identifier of the target resource is a resource identifier of the second type resource. A type identifier of a resource is used for identifying a type of a resource, and a conversion request may carry a first resource quantity, for example, 0.100.

In Step S404, a current resource conversion relationship between the first type resource and the second type resource can be obtained, and a second resource quantity can be obtained through calculation according to the current resource conversion relationship and the first resource quantity.

For example, the current resource conversion relationship is, for example, an ask rate of the first type resource relative to the second type resource. The first resource quantity is a quantity of original resources, and the second resource quantity is a quantity of target resources. The first resource quantity may be extracted from the first conversion request, and the second resource quantity corresponding to the first resource quantity is obtained according to the current resource conversion relationship between the first type resource and the second type resource. For example, it is assumed that the current resource conversion relationship is that an exchange rate of the first type resource to the second type resource is 1:2, if the first resource quantity is 10, the second resource quantity is 20.

In some embodiments, the intermediate server may store the current resource conversion relationship between the first type resource and the second type resource. The current resource conversion relationship includes a conversion relationship in which the first type resource is converted to the second type resource and a conversion relationship in which the second type resource is converted to the first type resource. For example, when the first type resource is RMB, and the second type resource is GBP, the current resource conversion relationship may include a price of RMB when RMB is converted to GBP or may include a price of RMB when GBP is converted to RMB. For example, when RMB and USD are exchanged, an ask rate of RMB is 7.02 yuan per dollar, and a bid rate of RMB is 6.98 yuan per dollar. That is, when RMB is exchanged for USD, 7.02 yuan may be exchanged for one dollar, and when USD is exchanged for RMB, one dollar may be exchanged for 6.98 yuan.

In some embodiments, the current resource conversion relationship stored in the intermediate server may be obtained according to a resource conversion relationship obtained from the resource conversion server. For example, the intermediate server may obtain exchange rates between resources transmitted by the resource conversion server every preset time period in real time.

In some embodiments, the step of obtaining a current resource conversion relationship includes: receiving a first resource conversion relationship transmitted by a resource conversion server, the first resource conversion relationship being a resource conversion relationship between the first type resource and the second type resource; and determining a second resource conversion relationship according to the first resource conversion relationship, and using the second resource conversion relationship as the current resource conversion relationship between the first type resource and the second type resource within a target time range.

For example, the first resource conversion relationship may include at least one of a conversion relationship in which the first type resource is converted to the second type resource or a conversion relationship in which the second type resource is converted to the first type resource. The first resource conversion relationship may be actively pushed to the intermediate server by the resource conversion server or the intermediate server may request the resource conversion server to transmit the first resource conversion relationship. For example, each time an exchange rate is changed, a server corresponding to a bank may transmit an updated exchange rate to a server (the intermediate server) of a third-party platform. Alternatively, when a bank signs an agreement with a third-party platform, and an exchange rate is updated once every preset time period such as everyday, the intermediate server may transmit a resource conversion relationship obtaining request to the bank server regularly such as at 0 o'clock everyday.

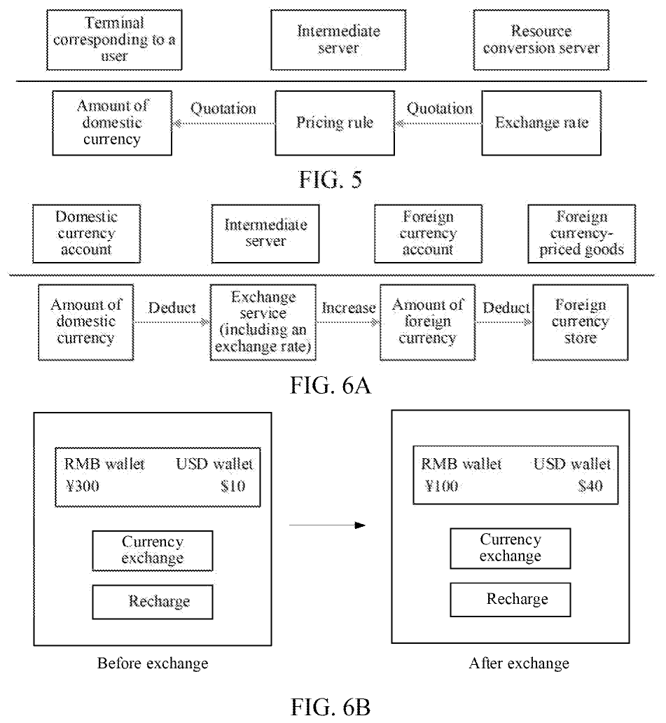

The intermediate server may use the first resource conversion relationship as the second resource conversion relationship, or may perform further calculation according to the first resource conversion relationship, to obtain the second resource conversion relationship. A specific calculation rule may be preset as required. For example, a target price may be obtained by multiplying a price of a resource by a preset value, subtracting a preset value, or adding a preset value. FIG. 5 is a schematic diagram of determining a resource conversion relationship according to some embodiments. The resource conversion server such as the bank server may transmit a price of a resource (quotation) to the intermediate server, that is, transmit the first resource conversion relationship. The intermediate server determines, according to the quotation of the bank and an additional price of the platform, a price of the resource when a user exchanges for the resource, that is, the second resource conversion relationship. The additional price of the platform is obtained according to a pricing rule pre-stored in the server. The intermediate server may determine, according to the price of the resource when the user exchanges for the resource, an amount of domestic currency that can be exchanged when a certain quantity of another currencies is exchanged for the domestic currency, and transmit the amount of domestic currency to a terminal corresponding to a user.

In an example, for exchange between RMB and USD, it is assumed that a first resource conversion relationship transmitted by the bank server is that an ask rate of RMB is 7.02 yuan, and a bid rate of RMB is 6.98 yuan. It is assumed that the ask rate is increased by 0.01 and the bid rate is reduced by 0.01 according to the pricing rule of the third-party platform, so that when a quote is offered to the user, an ask rate of RMB is 7.03 yuan and a bid rate of RMB is 6.97.

A length of the target time range may be determined according to an actual condition or a rule, for example, may be 24 hours. The current resource conversion relationship between the first type resource and the second type resource remains unchanged within the target time range. In an example, the bank may sign a price-fixing agreement with the third-party platform, to fix (or lock) an exchange rate price. The price-fixing agreement is a currency exchange agreement with a cooperative bank, which agrees to perform currency exchange at a fixed exchange rate within a specific time interval. Through the price-fixing agreement, excessively large relative fluctuation of the exchange rate can be avoided. Therefore, the intermediate server may regularly pull and update an exchange rate quotation of the bank by using an asynchronous task as a quotation within the target time range. In this way, when receiving a resource conversion request corresponding to the user and needing to determine a change of a quantity of resources in a resource account of the user according to a resource conversion relationship, the intermediate server does not need to obtain a real-time exchange rate from the resource conversion server, to reduce the pressure of the intermediate server.

In some embodiments, in the candidate resource conversion record set obtained by the intermediate server, first resource conversion times corresponding resource conversion records are within the target time range, that is, the first resource conversion times corresponding to the resource conversion records are within a same price-fixing period. The intermediate server may transmit a resource conversion request to the resource conversion server within the target time range, to reduce a financial risk. For example, if an exchange rate is updated once everyday, currency exchange records corresponding to users in the past hour may be obtained every one hour, to form a candidate resource conversion record set, a first resource conversion record(s) and a second resource conversion record(s) are obtained from the candidate resource conversion record set, steps S204 to S208 are performed, to transmit a currency exchange request to a resource conversion server corresponding to a bank and interact with the resource conversion server according to the currency exchange records generated in the past one hour, and uniform currency exchange is performed.

In Step S406, the first resource quantity of the first type resources is subtracted from a resource account corresponding to the target user, the second resource quantity of the second type resources is increased, and generate the first resource conversion record corresponding to the first conversion request.

For example, after the first resource quantity and the second resource quantity are obtained, because the user needs to perform currency exchange, the first resource quantity of original resources needs to be subtracted and the second resource quantity of target resources needs to be increased in a resource account of the user. In the first resource conversion record, an original resource is a first type resource and a target resource is a second type resource, a quantity of original resources is the first resource quantity, and a quantity of target resources is the second resource quantity.

In some embodiments, there may be a plurality of resource accounts corresponding to a target user. For example, the resource account corresponding to the target user may include a resource account corresponding to a first type resource and a resource account corresponding to a second type resource. Therefore, the first resource quantity of resources may be subtracted from the resource account corresponding to the first type resource, and the second resource quantity of resources may be increased to the resource account corresponding to the second type resource.

In some embodiments, the intermediate server may create an account corresponding each currency for a user. A resource quantity corresponding to each currency is displayed on a terminal according to a quantity of resources in each currency account, to increase the flexibility of resource transfer and resource conversion for users in different regions. For example. FIG. 6A is a diagram of a principle of currency exchange according to some embodiments. It is assumed that a user A is in China, a domestic currency is RMB, and there are a corresponding RMB account (a domestic currency account) and a corresponding USD account (a foreign currency account), even if the user wants to increase a quantity of dollars in the USD account, the user may first recharge the domestic currency account and then convert RMB to USD by using a currency exchange service provided by the server of the third-party platform without actually using USD to recharge. After the conversion, corresponding domestic currencies are subtracted from the RMB account of the user, and equivalent dollars are increased to the USD account. When a user wants to buy goods priced in foreign currency at a store that pays in foreign currency, the intermediate server may deduct a corresponding quantity of foreign currencies from a foreign currency account of the user, and an account of the foreign currency store may obtain the corresponding quantity of foreign currencies.

FIG. 6B is a schematic diagram of interfaces of a terminal before currency exchange and after currency exchange according to some embodiments. As shown in a left figure in FIG. 6B, that a user A has 300 yuan and 10 dollars is displayed in an electronic wallet of the user A. The user A may operate a terminal, for example, tapping/clicking a “currency exchange” key, and transmit a resource conversion request in which 200 yuan are exchanged for USD to the intermediate server by using the terminal through a series of operations. The intermediate server obtains that 200 yuan may be exchanged for 30 dollars according to a current exchange rate of RMB against USD. Therefore, the intermediate server converts 200 yuan in an RMB account of the user A into 30 dollars in a USD account. After the conversion, as shown in a right figure in FIG. 6B, because 200 yuan are subtracted from the RMB account of the user A, a balance is 300−200=10) yuan, and because 30 dollars are increased to the USD account, a balance is 10+30=40 dollars. After the conversion is completed, the intermediate server generates a resource conversion record.

It may be understood that the second resource conversion record may be generated according to a second conversion request transmitted by a user. The second conversion request is used for requesting to convert the second type resource to the first type resource. A third resource quantity corresponding to the first type resource and a fourth resource quantity corresponding to the second type resource are obtained according to the second conversion request. The third resource quantity of first type resources may be increased to a resource account of a first user, the fourth resource quantity of second type resources may be subtracted from the resource account corresponding to the target user, and the second resource conversion record is generated.

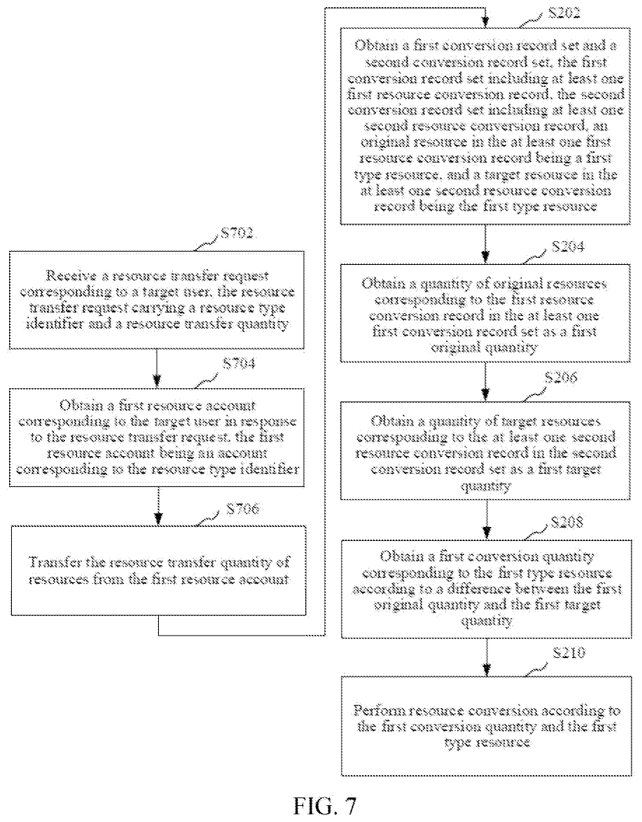

In some embodiments, as shown in FIG. 7, the resource conversion data processing method may further include the following steps in addition to S202-S210.

In Step S702, a resource transfer request corresponding to a target user is received, the resource transfer request carrying a resource type identifier and a resource transfer quantity.

For example, the resource transfer request corresponding to the target user is used for requesting to transfer a resource from an account of the target user. The resource transfer request corresponding to the target user may be transmitted by (from) a resource receiving terminal. The resource receiving terminal is a terminal corresponding to an account to which a resource needs to be transferred from a resource account corresponding to a user. For example, the resource receiving terminal may be a terminal corresponding to a merchant, for example, a cash register. When the target user buys goods from a store of the merchant, the user may perform payment by electronic payment, for example, by using a payment code, and a resource transfer terminal transmits a resource transfer request to the intermediate server according to the payment code. The resource transfer terminal may further obtain a payment collection amount entered by the merchant as a resource transfer quantity. The resource transfer terminal presets a resource type identifier used for identifying a type of a resource. For example, it is assumed that a merchant is in the United States, a resource type identifier may be an identifier of USD, for example, USD.

In Step S704, a first resource account corresponding to the target user is obtained in response to the resource transfer request, the first resource account being an account corresponding to the resource type identifier.

Specifically, the first resource account is an account corresponding to the resource type identifier carried by the resource transfer request. For example, if the resource type identifier is USD, the first resource account is a USD account of the target user.

In Step S706, the resource transfer quantity of resources is transferred from the first resource account.

Specifically, the resource transfer request may further carry an account identifier of a receiving account corresponding to the resource transfer terminal. Therefore, a resource transfer quantity of resources in the first resource account may be transferred to the receiving account corresponding to the resource transfer terminal.

In this embodiment of this application, resource transfer may be directly performed from a first resource account corresponding to a target user by using a resource type identifier in a resource transfer request, thereby improving the resource transfer efficiency. Steps S702 to S706 are applicable to an overseas payment scenario. For example, when a domestic currency account of a user is an RMB account, if the user arrives in another geographical region, a domestic currency used in the geographical region is different from the domestic currency of the user, and in this geographical region, a price in a store is marked by using a domestic currency. If a single currency account is used, and currency conversion is performed according to an exchange rate during payment, the user can only passively accept the current exchange rate. For example, the current exchange rate is not good for the user, but an interest rate of last month is actually very advantageous, and there is no way for the user to reserve specific currencies in advance according to preferences. Moreover, real-time calculation is also easy to cause confusion and distrust. Because a transaction occurs in an instant, and the currency involves conversion calculation, the user cannot immediately determine whether the deducted amount of the domestic currency is equivalent to a price of a commodity marked by using a foreign currency. For example, if the price is 10 dollars, but 71 yuan are charged from the RMB account of the user, it is difficult for the user to determine that 71 yuan are equivalent to 10 dollars, and it is easy to cause distrust. However, according to the resource transfer request, a resource type identifier and a resource transfer quantity are carried, and 10 dollars are automatically deducted from the USD account, which can not only reduce the amount of calculation, but also make it easier for the user to understand and accept.

It may be understood that steps S702 to S706 and steps S202 to S210 may be performed synchronously, or steps S702 to S706 are first performed, or steps S202 to S210 are first performed in the FIG. 7 example.

The resource conversion data processing method provided in this embodiment of this application is applicable to a currency exchange service scenario provided by a third-party platform. A server of the third-party platform may enable a user to have accounts corresponding to a plurality of currencies in an electronic wallet and to expand a resource usage scenario. The user can flexibly determine a time of currency exchange according to a current exchange rate, and perform exchange between currencies supported by the electronic wallet by using a currency exchange channel through a terminal, which can improve the utilization rate of funds. During exchanging, a domestic currency core principle may be adopted, with a domestic currency as a core, that is, as a middle currency. For an exchange rate between any two non-domestic currencies, reference may be made to respective exchange rates relative to a domestic currency. For example, RMB:JPY=1:15, and USD:RMB=1.7, so that USD:JPY=1:105. During a transaction, a user can choose to directly pay a currency priced by using a domestic (local) currency through a terminal (for example, USD supports USD-priced goods). This not only provides the user with an opportunity to actively choose a currency and an exchange rate, but also alleviates the confusion that the user is difficult to confirm whether paid domestic currency is equivalent to a quoted currency when performing payment by using the domestic currency during a real-time transaction. In addition, the currency for payment can also be automatically determined by the intermediate server. For example, when the intermediate server receives a resource transfer request transmitted by a cash register of a merchant, a corresponding resource account may be determined according to a resource type identifier.

Because an exchange rate may be constantly changing, to reduce the financial risk of a platform, the platform may sign a price-fixing agreement with a cooperative bank, agreeing that the exchange rate will remain constant for a certain period of time. Therefore, when receiving a resource price transmitted by a resource conversion server corresponding to the bank, the intermediate server may fix the price, that is, within a target time range, for example, within one day, two days, 12 hours, and the like, process a currency exchange application of a user by using the same exchange rate. The intermediate server can change balances in various currency accounts of the users in real time according to the current resource price. To reduce an amount of interactions with the resource conversion server, before each price-fixing period ends, the intermediate server may complete offset of resource quantities between resource conversion records in opposite conversion directions, to obtain a quantity of resources that need to be transferred in or transferred out, and transmit one currency exchange request to the server, to process a batch of resource conversion records.

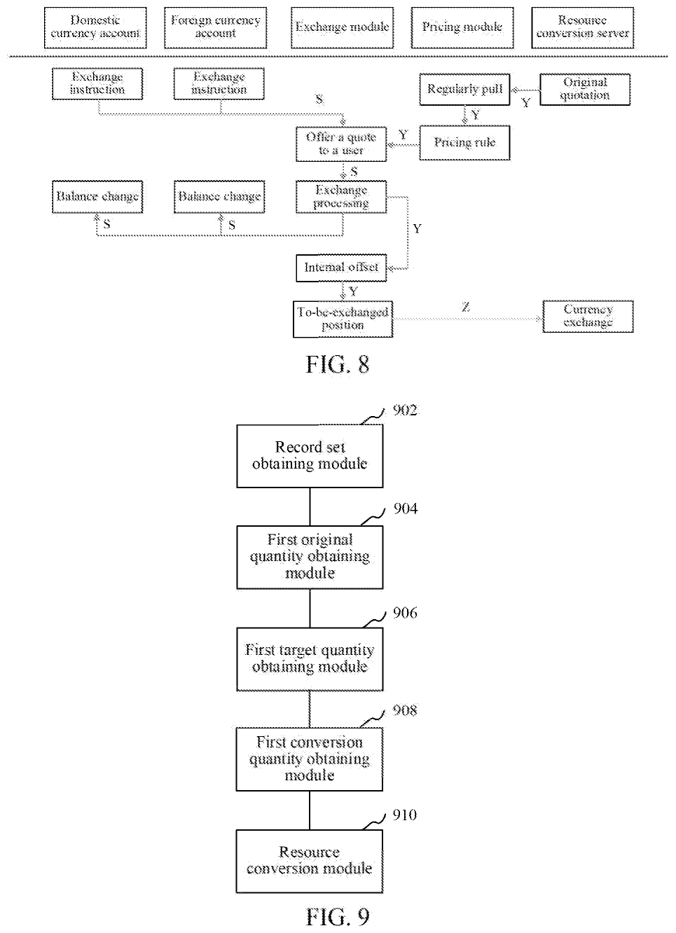

FIG. 8 is a schematic diagram of an implementation principle of a resource conversion data processing method according to an embodiment of this application. In FIG. 8, a connecting line labeled as S represents a real-time information link, a connecting line labeled as Y represents an asynchronous information link, and a connecting line labeled as Z represents a fund flow. The resource conversion data processing method provided by this embodiment of this application is described below with reference to FIG. 8, and the method includes the following steps.

In step 1, a first resource conversion relationship transmitted by a resource conversion server can be received, the first resource conversion relationship being a resource conversion relationship between the first type resource and the second type resource, such as a currency exchange rate.

In an example, as shown in FIG. 8, the intermediate server may regularly pull a currency exchange quotation (an original quotation) of a bank from a resource conversion server such as a bank server by using an asynchronous task, for example, a price of RMB against USD. A task of regularly pulling the quotation of the bank may be performed by using a regular asynchronous task, which can ensure timeliness without interfering with a real-time transaction link, and there is no need for the real-time transaction link to query quotations from the resource conversion server one by one. For example, the transaction link is a link of processing a currency exchange request of a user.

In step 2, a second resource conversion relationship according to the first resource conversion relationship can be determined, and the second resource conversion relationship can be used as the current resource conversion relationship between the first type resource and the second type resource within a target time range.

In an example, after the quotation is obtained through pulling, as shown in FIG. 8, a pricing module of the intermediate server may form a quotation for a user according to a preset pricing rule as a currency exchange quotation of the day.

In step 3 a first conversion request transmitted by a terminal corresponding to a target user can be received, the first conversion request being used for requesting the intermediate server to convert the first type resource to second type resources.

As shown in FIG. 8, the user may initiate an exchange instruction (requesting the intermediate server to exchange currencies) by operating a terminal and by using a foreign currency account or a domestic currency account, and an exchange module in the intermediate server receives the exchange instruction.

In step 4, a first resource quantity corresponding to the first type resource and a second resource quantity corresponding to the second type resource can be obtained according to the first conversion request.

In step 5, the first resource quantity of the first type resources can be subtracted from a resource account corresponding to the target user, the second resource quantity of the second type resources can be added to the resource account corresponding to the target user, and the first resource conversion record can be generate.

As shown in FIG. 8, the exchange module responds to a currency exchange request transmitted by the terminal of the user in real time according to a current quotation formed for the user, which may be specifically represented as that balances of different currency accounts of the user will be changed. It may be understood that a second resource conversion record may be generated according to a second conversion request of another user. Generally, a resource conversion record can be generated for each transaction at the intermediate server for each exchange request from a user.

In step 6, a first conversion record set and a second conversion record set can be obtained, the first conversion record set including at least one first resource conversion record, the second conversion record set including at least one second resource conversion record, an original resource in the first resource conversion record being a first type resource, and a target resource in the second resource conversion record being the first type resource, in an example.

In step 7, a quantity of original resources corresponding to the one or more first resource conversion records in the first conversion record set can be obtained as a first original quantity.

In Step 8, a quantity of target resources corresponding to the one or more second resource conversion records in the second conversion record set can be obtained as a first target quantity.

In step 9, a first conversion quantity corresponding to the first type resource according to a difference between the first original quantity and the first target quantity can be obtained.

In step 10, a resource conversion according to the first conversion quantity and the first type resource can be formed.

In an example, an internal offset mechanism may be set (configured) in the intermediate server, resource conversion records with opposite resource conversion directions may be obtained, and resource quantities are offset against each other. One or more batch offset tasks may be performed within one price-fixing circle. That is, quantities of the same type of resources but in different conversion directions are offset against each other, to obtain a finally exchanged quantity of resources. For example, a resource conversion record in which RMB is exchange for USD may be obtained as a first resource conversion record. A resource conversion record in which USD is exchange for RMB is obtained as a second resource conversion record, a quantity of original resources, that is, RMB, in the first resource conversion record is obtained as a first original quantity, and a quantity of target resources, that is, RMB, in the second resource conversion record is obtained as a first target quantity, and the first target quantity is offset against the first original quantity, that is, an absolute value of a difference between the first target quantity and the first original quantity is used as a first resource exchange quantity, that is, used as an exchanged quantity of RMB. If the first original quantity is greater than the first target quantity, RMB may be transferred out. If the first original quantity is less than the first target quantity, RMB may be transferred in. After a to-be-exchange position is obtained, an exchange request may be transmitted to a server corresponding to a bank, to complete actual currency exchange. In this embodiment of this application, the fluctuation of a transaction is controlled through a regular price-fixing mechanism, and the scale of the transaction is controlled through an internal offset mechanism. Parallel execution of the regular price-fixing mechanism and the internal offset mechanism realizes the optimization of the exchange risk. Therefore, when it is ensured that an operator of an electronic wallet can provide a real-time currency exchange service for a user, the risk of loss in the foreign exchange fluctuation can be controlled as much as possible, and a quantity of interactions with a resource exchange server can be reduced.

In some embodiments, a computer program product or a computer program is provided. The computer program product or the computer program includes computer instructions, and the computer instructions are stored in a computer-readable storage medium. The processor of the computer device reads the computer instructions from the computer-readable storage medium, and the processor executes the computer instructions, to cause the computer device to perform the steps in the method embodiments.

It is to be understood that although the steps in the flowchart are sequentially shown according to indication of an arrow, the steps are not necessarily sequentially performed according to a sequence indicated by the arrow. Unless otherwise explicitly specified in this application, execution of the steps is not strictly limited, and the steps may be performed in other sequences or omitted. In addition, at least some steps in the flowcharts may include a plurality of steps or a plurality of stages. The steps or the stages are not necessarily performed at the same moment, but may be performed at different moments. The steps or the stages are not necessarily performed in sequence, but may be performed in turn or alternately with another step or at least some of steps or stages of the another step.

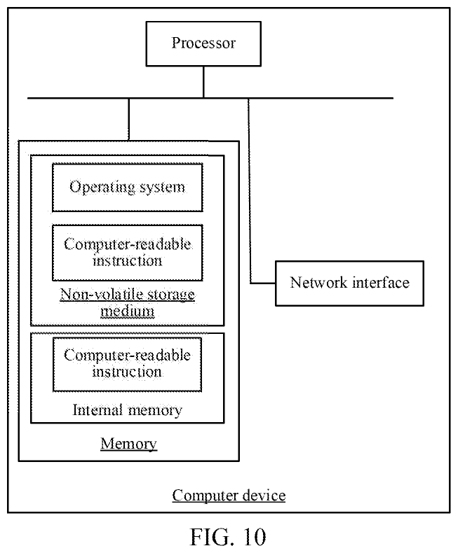

In some embodiments, As shown in FIG. 9, a resource conversion data processing apparatus is provided, the apparatus may be implemented as a part of a computer device by using a software module or a hardware module (processing circuitry) or a combination thereof, and the apparatus specifically includes: a record set obtaining module 902, a first original quantity obtaining module 904, a first target quantity obtaining module 906, a first conversion quantity obtaining module 908, and a resource conversion module 910.

The record set obtaining module 902 is configured to obtain a first conversion record set and a second conversion record set, the first conversion record set including at least one first resource conversion record, the second conversion record set including at least one second resource conversion record, an original resource in the first resource conversion record being a first type resource, and a target resource in the second resource conversion record being the first type resource.

The first original quantity obtaining module 904 is configured to obtain a quantity of original resources corresponding to the first resource conversion record in the first conversion record set as a first original quantity.

The first target quantity obtaining module 906 is configured to obtain a quantity of target resources corresponding to the second resource conversion record in the second conversion record set as a first target quantity.

The first conversion quantity obtaining module 908 is configured to obtain a first conversion quantity corresponding to the first type resource according to a difference between the first original quantity and the first target quantity.

The resource conversion module 910 is configured to perform resource conversion according to the first conversion quantity and the first type resource.

In some embodiments, the resource conversion module 910 includes: a target conversion manner determining unit, configured to determine a target conversion manner corresponding to the first type resource, the target conversion manner being determined according to a magnitude relationship between the first original quantity and the first target quantity; and a resource conversion unit, configured to convert the first conversion quantity of the first type resources in the target conversion manner.

In some embodiments, in response to the first original quantity being greater than the first target quantity, the target conversion manner is transfer-out, and the resource conversion unit is configured to transmit a target conversion request to a resource conversion server, the target conversion request being used for requesting to transfer out the first conversion quantity of the first type resources.

In some embodiments, in response to the first original quantity being less than the first target quantity, the target conversion manner is transfer-in, and the resource conversion unit is configured to transmit a target conversion request to a resource conversion server, the target conversion request being used for requesting to transfer in the first conversion quantity of the first type resources.

In some embodiments, a target resource in the first resource conversion record is a second type resource, an original resource in the second resource conversion record is the second type resource, and the resource conversion module 910 is configured to: transmit a target conversion request to a resource conversion server, the target conversion request being used for requesting to convert the second type resources to the first conversion quantity of the first type resources or convert the first conversion quantity of first type resources to the second type resources.

In some embodiments, the record set obtaining module 902 is configured to obtain a resource conversion record with an original resource being the first type resource and a target resource being the second type resource from a candidate resource conversion record set corresponding to a first resource conversion time range as the first resource conversion record, to form the first conversion record set; and obtain a resource conversion record with an original resource being the second type resource and a target resource being the first type resource from the candidate resource conversion record set as the second resource conversion record, to form the second conversion record set.

In some embodiments, the resource conversion data processing apparatus further includes: a first conversion request receiving module, configured to receive a first conversion request transmitted by a terminal corresponding to a target user, the first conversion request being used for requesting to convert the first resource quantity of the first type resources to second type resources; a second resource quantity obtaining module, configured to obtain a current resource conversion relationship between the first type resource and the second type resource, and obtain a second resource quantity through calculation according to the current resource conversion relationship and the first resource quantity; and a generation module, configured to subtract the first resource quantity of the first type resources from a resource account corresponding to the target user, increase the second resource quantity of the second type resources, and generate the first resource conversion record.

In some embodiments, the resource conversion data processing apparatus further includes: a first resource conversion relationship receiving module, configured to receive a first resource conversion relationship transmitted by a resource conversion server, the first resource conversion relationship being a resource conversion relationship between the first type resource and the second type resource; and a second resource conversion relationship determining module, configured to determine a second resource conversion relationship according to the first resource conversion relationship, and use the second resource conversion relationship as the current resource conversion relationship between the first type resource and the second type resource within a target time range.

The modules in the foregoing resource conversion data processing apparatus may be implemented entirely or partially by software, hardware (processing circuitry), or a combination thereof. The foregoing modules may be built in or independent of a processor of a computer device in a hardware form, or may be stored in a memory of the computer device in a software form, so that the processor invokes and performs an operation corresponding to each of the foregoing modules.

In some embodiments, a computer device is provided. The computer device may be a server, and an internal structure diagram thereof may be shown in FIG. 10. The computer device includes a processor, a memory, and a network interface that are connected by using a system bus. The processor of the computer device is configured to provide computing and control capabilities. The memory of the computer device includes a non-volatile storage medium and an internal memory. The non-volatile storage medium stores an operating system, computer-readable instructions, and a database. The internal memory provides an environment for running of the operating system and the computer-readable instructions in the non-volatile storage medium. The database of the computer device is configured to store a resource conversion record. The network interface of the computer device is configured to communicate with an external terminal through a network connection. The computer readable instructions, when executed by the processor, implement the resource conversion data processing method.

A person skilled in the art may understand that, the structure shown in FIG. 10 is only a block diagram of a part of a structure related to a solution of this application and does not limit the computer device to which the solution of this application is applied. Specifically, the computer device may include more or fewer members than those in the drawings, or include a combination of some members, or include different member layouts.

In some embodiments, a computer device is provided, including a memory and a processor, the memory storing computer-readable instructions, the processor, when executing the computer-readable instructions, implementing the steps in the foregoing method embodiments.

In some embodiments, a non-transitory computer-readable storage medium is provided, storing computer-readable instructions, the computer-readable instructions, when executed by a processor, implementing the steps in the foregoing method embodiments.

A person of ordinary skill in the art may understand that all or some of the procedures of the methods of the foregoing embodiments may be implemented by computer-readable instructions instructing relevant hardware. The computer-readable instructions may be stored in a non-transitory computer-readable storage medium. When the computer-readable instructions are executed, the procedures of the embodiments of the foregoing methods may be included. Any reference to a memory, a storage, a database, or another medium used in the embodiments provided in this application may include at least one of a non-volatile memory and a volatile memory. The non-volatile memory may include a read-only memory (ROM), a magnetic tape, a floppy disk, a flash memory, an optical memory, and the like. The volatile memory may include a random access memory (RAM) or an external cache. For the purpose of description instead of limitation, the RAM is available in a plurality of forms, such as a static RAM (SRAM) or a dynamic RAM (DRAM).

Technical features of the foregoing embodiments may be combined in different manners. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this application, which are described specifically and in detail, but cannot be construed as a limitation to the patent scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A resource conversion method, the method comprising:
determining, by processing circuitry of an information processing apparatus, a first conversion record set and a second conversion record set, the first conversion record set comprising at least one first resource conversion record, the second conversion record set comprising at least one second resource conversion record, an original resource being converted to a target resource in each of the at least one first resource conversion record and the at least one second resource conversion record, the original resource in each of the at least one first resource conversion record being a first type resource, and the target resource in each of the at least one second resource conversion record being the first type resource;
determining, by the processing circuitry of the information processing apparatus, a quantity of original resources corresponding to the at least one first resource conversion record in the first conversion record set as a first original quantity;
determining, by the processing circuitry of the information processing apparatus, a quantity of target resources corresponding to the at least one second resource conversion record in the second conversion record set as a first target quantity;
determining, by the processing circuitry of the information processing apparatus, a first conversion quantity corresponding to the first type resource according to a difference between the first original quantity and the first target quantity; and
performing, by the processing circuitry of the information processing apparatus, resource conversion between the first type resource and a resource of a different type according to the first conversion quantity corresponding to the first type resource.

2. The method according to claim 1, wherein the performing comprises:
determining a target conversion manner corresponding to the first type resource, the target conversion manner being determined according to a magnitude relationship between the first original quantity and the first target quantity, the target conversion manner indicating whether the resource conversion is transfer-out where the first type of resource is converted to the resource of the different type or transfer-in where the resource of the different type is converted to the first type of resources; and
converting the first conversion quantity of the first type resource according to the target conversion manner.

3. The method according to claim 2, wherein in response to the first original quantity being greater than the first target quantity, the target conversion manner is transfer-out, and the converting comprises:
transmitting a target conversion request to a conversion server, the target conversion request being used for requesting the conversion server to convert the first conversion quantity of the first type resource to the resource of the different type.

4. The method according to claim 2, wherein in response to the first original quantity being less than the first target quantity, the target conversion manner is transfer-in, and the converting comprises:
transmitting a target conversion request to a conversion server, the target conversion request being used for requesting the conversion server to convert a resource of a different type to the first conversion quantity of the first type resource.

5. The method according to claim 1, wherein the target resource in each of the at least one first resource conversion record is a second type resource, the original resource in each of the at least one second resource conversion record is the second type resource, and the performing comprises:
transmitting a target conversion request to a conversion server, the target conversion request being used for requesting the conversion server to convert the second type resources to the first conversion quantity of the first type resources or convert the first conversion quantity of the first type resources to the second type resources.

6. The method according to claim 5, wherein the determining the first conversion record set and the second conversion record set comprises:
obtaining a resource conversion record with an original resource being the first type resource and a target resource being the second type resource from a candidate resource conversion record set as the first resource conversion record, to form the first conversion record set; and
obtaining a resource conversion record with an original resource being the second type resource and a target resource being the first type resource from the candidate resource conversion record set as the second resource conversion record, to form the second conversion record set.

7. The method according to claim 1, further comprising:
receiving a first conversion request transmitted by a terminal corresponding to a target user for converting a first resource quantity of the first type resource to a second type resource;
obtaining a current resource conversion relationship between the first type resource and the second type resource,
obtaining a second resource quantity of the second type resource according to the current resource conversion relationship and the first resource quantity; and
subtracting the first resource quantity of the first type resource from a first resource account corresponding to the target user,
adding the second resource quantity of the second type resource to a second resource account corresponding to the target user, and
generating one of the at least one first resource conversion record corresponding to the first conversion request.

8. The method according to claim 7, further comprising:
receiving a first resource conversion relationship transmitted by a conversion server, the first resource conversion relationship being a resource conversion relationship between the first type resource and the second type resource; and
determining a second resource conversion relationship according to the first resource conversion relationship, and
using the second resource conversion relationship as the current resource conversion relationship between the first type resource and the second type resource within a target time range.

9. The method according to claim 1, further comprising:
receiving a resource transfer request corresponding to a target user, the resource transfer request carrying a resource type identifier and a resource transfer quantity;
obtaining a third resource account corresponding to the target user in response to the resource transfer request, the third resource account being an account corresponding to the resource type identifier; and
transferring the resource transfer quantity of a resource of the resource type identifier out of the third resource account.

10. A resource conversion server, comprising:
processing circuitry configured to
determine a first conversion record set and a second conversion record set, the first conversion record set comprising at least one first resource conversion record, the second conversion record set comprising at least one second resource conversion record, an original resource being converted to a target resource in each of the at least one first resource conversion record and the at least one second resource conversion record, the original resource in each of the at least one first resource conversion record being a first type resource, and the target resource in each of the at least one second resource conversion record being the first type resource;
determine a quantity of original resources corresponding to the at least one first resource conversion record in the first conversion record set as a first original quantity;
determine a quantity of target resources corresponding to the at least one second resource conversion record in the second conversion record set as a first target quantity;
determine a first conversion quantity corresponding to the first type resource according to a difference between the first original quantity and the first target quantity; and
perform resource conversion between the first type resource and a resource of a different type according to the first conversion quantity corresponding to the first type resource.

11. The server according to claim 10, wherein the processing circuitry is further configured to:
determine a target conversion manner corresponding to the first type resource, the target conversion manner being determined according to a magnitude relationship between the first original quantity and the first target quantity, the target conversion manner indicating whether the resource conversion is transfer-out where the first type of resource is converted to the resource of the different type or transfer-in where the resource of the different type is converted to the first type of resources; and
convert the first conversion quantity of the first type resource according to the target conversion manner.

12. The server according to claim 11, wherein in response to the first original quantity being greater than the first target quantity, the target conversion manner is transfer-out, and the processing circuitry is further configured to:
transmit a target conversion request to a conversion server, the target conversion request being used for requesting the conversion server to convert the first conversion quantity of the first type resource to the resource of the different type.

13. The server according to claim 11, wherein in response to the first original quantity being less than the first target quantity, the target conversion manner is transfer-in, and the processing circuitry is further configured to:
transmit a target conversion request to a conversion server, the target conversion request being used for requesting the conversion server to convert a resource of a different type to the first conversion quantity of the first type resource.

14. The server according to claim 10, wherein the target resource in each of the at least one first resource conversion record is a second type resource, the original resource in each of the at least one second resource conversion record is the second type resource, and the processing circuitry is further configured to:
transmit a target conversion request to a conversion server, the target conversion request being used for requesting the conversion server to convert the second type resources to the first conversion quantity of the first type resources or convert the first conversion quantity of the first type resources to the second type resources.

15. The server according to claim 14, wherein the processing circuitry is further configured to:
obtain a resource conversion record with an original resource being the first type resource and a target resource being the second type resource from a candidate resource conversion record set as the first resource conversion record, to form the first conversion record set; and
obtain a resource conversion record with an original resource being the second type resource and a target resource being the first type resource from the candidate resource conversion record set as the second resource conversion record, to form the second conversion record set.

16. The server according to claim 10, wherein the processing circuitry is further configured to:
receive a first conversion request transmitted by a terminal corresponding to a target user for converting a first resource quantity of the first type resource to a second type resource;
obtain a current resource conversion relationship between the first type resource and the second type resource,
obtain a second resource quantity of the second type resource according to the current resource conversion relationship and the first resource quantity; and
subtract the first resource quantity of the first type resource from a first resource account corresponding to the target user,
add the second resource quantity of the second type resource to a second resource account corresponding to the target user, and
generate one of the at least one first resource conversion record corresponding to the first conversion request.

17. The server according to claim 16, wherein the processing circuitry is further configured to:
receive a first resource conversion relationship transmitted by a conversion server, the first resource conversion relationship being a resource conversion relationship between the first type resource and the second type resource; and
determine a second resource conversion relationship according to the first resource conversion relationship, and
use the second resource conversion relationship as the current resource conversion relationship between the first type resource and the second type resource within a target time range.

18. The server according to claim 10, wherein the processing circuitry is further configured to:
receive a resource transfer request corresponding to a target user, the resource transfer request carrying a resource type identifier and a resource transfer quantity;
obtain a third resource account corresponding to the target user in response to the resource transfer request, the third resource account being an account corresponding to the resource type identifier; and
transfer the resource transfer quantity of a resource of the resource type identifier out of the third resource account.

19. A non-transitory computer-readable storage medium storing instructions, which when executed by at least one processor, cause the at least one processor to perform:
determining a first conversion record set and a second conversion record set, the first conversion record set comprising at least one first resource conversion record, the second conversion record set comprising at least one second resource conversion record, an original resource being converted to a target resource in each of the at least one first resource conversion record and the at least one second resource conversion record, the original resource in each of the at least one first resource conversion record being a first type resource, and the target resource in each of the at least one second resource conversion record being the first type resource;
determining a quantity of original resources corresponding to the at least one first resource conversion record in the first conversion record set as a first original quantity;
determining a quantity of target resources corresponding to the at least one second resource conversion record in the second conversion record set as a first target quantity;
determining a first conversion quantity corresponding to the first type resource according to a difference between the first original quantity and the first target quantity; and
performing resource conversion between the first type resource and a resource of a different type according to the first conversion quantity corresponding to the first type resource.

20. The non-transitory computer-readable storage medium according to claim 19, wherein the performing the resource conversion comprises:
determining a target conversion manner corresponding to the first type resource, the target conversion manner being determined according to a magnitude relationship between the first original quantity and the first target quantity, the target conversion manner indicating whether the resource conversion is transfer-out where the first type of resource is converted to the resource of the different type or transfer-in where the resource of the different type is converted to the first type of resources; and
converting the first conversion quantity of the first type resource according to the target conversion manner.
